(19) United States
(12) Patent Application Publication
(10) Pub. No.: US 2016/0308244 A1
(43) Pub. Date: Oct. 20, 2016

(54) LITHIUM-OXIDE GARNET BATCH COMPOSITION AND SOLID ELECTROLYTE MEMBRANE THEREOF

(71) Applicant: Corning Incorporated, Corning, NY (US)

(72) Inventors: Michael Edward Badding, Campbell, NY (US); Lanrik Wayne Kester, Savona, NY (US); Zhen Song, Painted Post, NY (US)

(21) Appl. No.: 15/088,773

(22) Filed: Apr. 1, 2016

Related U.S. Application Data
(60) Provisional application No. 62/147,078, filed on Apr. 14, 2015.

(51) Int. Cl. H01M 10/0562; H01M 10/0525

(52) U.S. Cl. CPC H01M 10/0562; H01M 10/0525; H01M 2300/0068

(57) ABSTRACT

A W and Ga co-doped garnet batch composition or Ta and Ga co-doped garnet batch composition including:
a source of elemental Li in from 41 to 56 mol %;
a source of elemental La in from 25 to 28 mol %;
a source of elemental Zr in from 13 to 17 mol %; and
a source of elemental co-dopant comprising a mixture of: a first dopant compound having gallium in from 2 to 17 mol %, and a second dopant compound having tungsten or tantalum in from 0.8 to 5 mol %, based on a batch total of 100 mol %.

Also disclosed is a method of making and using the W and Ga co-doped garnet composition or Ta and Ga co-doped garnet composition, as defined herein, in an energy storage device.

This application claims the benefit of priority under 35 U.S.C. §119 of U.S. Provisional Application Ser. No. 62/147,078 filed on Apr. 14, 2015 the content of which is relied upon and incorporated herein by reference in its entirety.

The present application is related to commonly owned and assigned provisional patent application U.S. Ser. No. 62/064,605, filed Oct. 16, 2014, entitled “METHOD OF MAKING LITHIUM-ION CONDUCTIVE GARNET AND MEMBRANES THEREOF,” but does not claim priority thereto.

The entire disclosure of each publication or patent document mentioned herein is incorporated by reference.

### BACKGROUND

The present disclosure relates to a lithium-ion conductive solid electrolyte compositions and membranes thereof.

### SUMMARY

In embodiments, the disclosure provides:

a lithium-oxide garnet batch composition and a solid electrolyte membrane thereof;

a Li-metal containing energy storage device including the disclosed solid electrolyte membrane; and

a method of making: the lithium-oxide garnet batch composition, the lithium-oxide garnet composition, the solid electrolyte membrane thereof, and a Li-metal containing energy storage article or device.

### BRIEF DESCRIPTION OF THE DRAWINGS

In embodiments of the disclosure:

FIG. 1 shows PRIOR ART SEM images of: a 0.3Ga-LLZO (a); a 0.4Ga-LLZO (b); a 0.5Ga-LLZO (c); 1.0Ga-LLZO pellets after being fired to 1080° C. (d); and SEM images (e) and (f) are cross-sections of 0.3 Ga-LLZO and 1.0 Ga-LLZO samples, respectively (see H. E. Shinawi, et al., and J. Wolfenstine, references below).

FIG. 2 shows Applicant's previous PRIOR ART polished cross-sectional SEM images of a 0.6 Ga-LLZO after fired to 1050° C., as disclosed in the abovementioned co-pending U.S. Ser. No. 62/064,605. A huge grain size was developed that spans the entire thickness of the pellets.

FIG. 3 shows Applicant's previous PRIOR ART polished cross-sectional SEM image of a 0.2Ga-LLZO after being fired to 1180° C., as disclosed in the abovementioned co-pending U.S. Ser. No. 62/064,605.

FIGS. 4A and 4B show the particle size distribution of a disclosed jet milled cubic garnet powder (FIG. 4A), and an attrition milled garnet powder (FIG. 4B), respectively.

FIGS. 5A and 5B, respectively, show SEM images of the polished cross-section of: a W and Ga co-doped garnet (FIG. 5A); and a Ga only doped garnet (FIG. 5B).

FIGS. 6A and 6B show SEM images of fired W and Ga co-doped garnet tapes.

FIGS. 7A to 7E show fractured cross-section SEM images of selected garnet composition membranes made by pellet pressing after sintering at 950° C. for 30 hrs.

FIG. 8 shows cell test measurement results for an exemplary 0.5 mm thick doped garnet (MAA) pellet at a current density of 0.5 mA/cm².

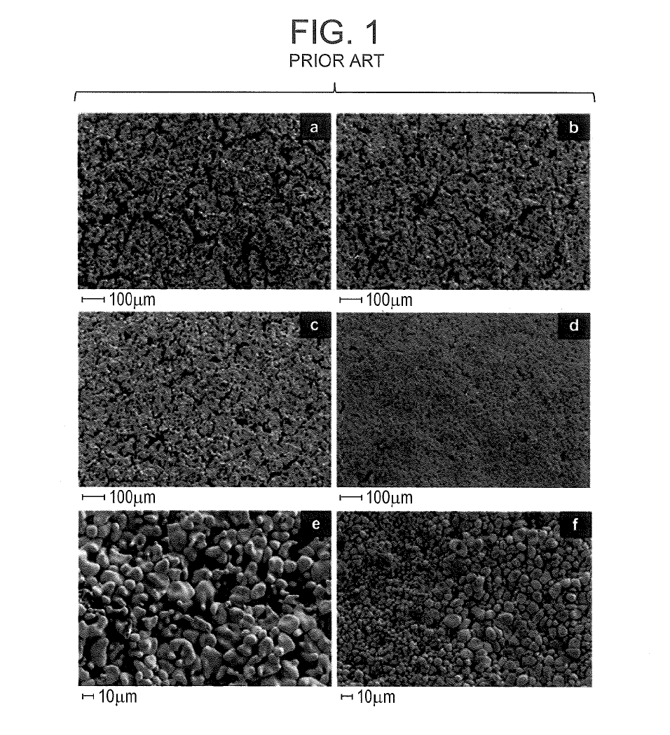

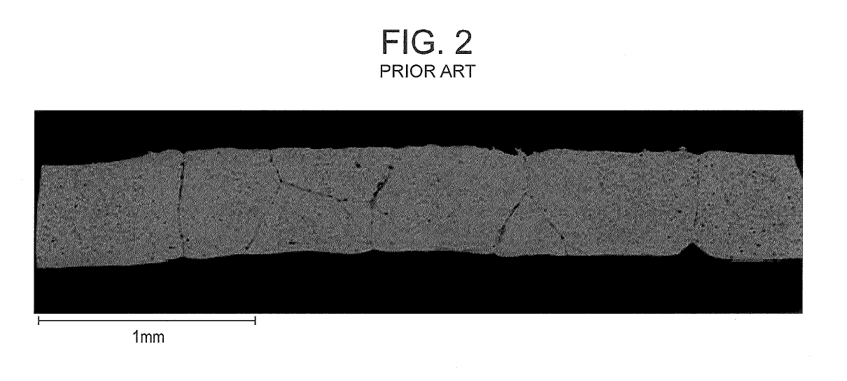

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

In embodiments, the disclosed method of making and using provide one or more advantageous features or aspects, including for example as discussed below. Features or aspects recited in any of the claims are generally applicable to all facets of the invention. Any recited single or multiple feature or aspect in any one claim can be combined or permuted with any other recited feature or aspect in any other claim or claims.

### DEFINITIONS

“Nominal,” “nominal formula,” or like terms, in the context of the disclosed garnet compositions and formulas, refer to an exact garnet composition or an exact formula, as determined by, for example, ICP. The disclosed garnet batch compositions each include a 10 wt % Li excess, which excess Li is substantially incorporated in the resulting nominal garnet composition. The disclosed nominal garnet compositions and formulas, which contains more than twelve (12) oxygen atoms, are different from a pure garnet formula, which contains only 12 oxygen atoms. The disclosed garnet compositions contain trace amounts of a second phase, such as a lithium gallate phase or a pyrochlore (La₂Zr₂O₇) phase, as demonstrated by the XRD results (see Tables 2, 3 and 6 below).

“LLZO,” or like terms refer, for example, to a solid lithium garnet composition of the formula Li₇La₃Zr₂O₁₂.

“Membrane” or “pellet” or like terms refer, for example, to a solid electrolyte component, which is part of the exterior walls of a lithium ion battery cell or like articles.

“Sinter” or like terms refer, for example, to cause to become a coherent mass by heating without melting.

“Calcine,” “calcination,” or like terms refer, for example, to heating to a high temperature, but without fusing, to drive off volatile matter or to effect changes.

“Firing,” “fire,” or like terms refer, for example, to the process of maturing ceramic products by the application of heat.

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The composition and methods of the disclosure can include any value or any combination of the values, specific values, more specific values, and preferred values described herein, including explicit or implicit intermediate values and ranges.

Li-ion conductive solid electrolyte compositions are attractive for next generation Li-ion based batteries. Solid electrolytes offer improved safety and reliability compared to liquid electrolytes, which liquid electrolytes can present safety and reliability problems. Reliability issues are particularly challenging with respect to anodes incorporating Li-metal. Solid electrolyte compositions based on garnet type materials are particularly attractive as they have been shown to be stable against Li metal, which could potentially enable practical use of Li-metal as the anode material. A thin garnet membrane is desired for achieving high cell energy density.

High conductivity Li-ion garnet (Li₇La₃Zr₂O₁₂, “LLZO”) has two phases: tetragonal and cubic. The Li-ion conductivity of the cubic phase garnet was found to be two orders of magnitude higher than the tetragonal phase. Garnet has a high melting temperature (e.g., greater than 1200° C.). High temperature firing can cause difficulties in electrolyte film fabrication, such as Li-loss and sticking of the garnet sample to a support. These difficulties are more acute when the samples are in thin membrane form.

Doping of the garnet can stabilize the cubic phase. The dopants can partially substitute for any of the elements in the Li-ion garnet formula (Li₇La₃Zr₂O₁₂, “LLZO”). Aluminum doping to substitute for Li has been extensively studied. Among the garnet doping studies, Ga was also used for doping to substitute for Li (see H. E. Shinawi, et al., Stabilization of cubic lithium-stuffed garnets of the type “Li₇La₃Zr₂O₁₂” by addition of gallium, J. Power Sources, 225 (2013) 13, and J. Wolfenstine, et al., Synthesis and high Li-ion conductivity of Ga-stabilized cubic Li₇La₃Zr₂O₁₂, Materials Chemistry and Physics, 134 (2012) 571). Shinawi reported that extra Ga doping can effectively sinter the garnet, and with a sintering temperature of 1080° C. a Li-ion conductivity of 5.4×10⁻⁴ S/cm was obtained, when doped at 1 mol Ga in 1 mol garnet. Shinawi attempted Ga doping at different levels at, e.g., 0.1 mol to 1.0 mol of Ga in 1 mol garnet. Only the 1 mol doping sintered to a dense part. The grain size from their SEM image was not uniform having one part with a grain size of about 5 microns and another part having a gain size of about 15 microns. From their experimental results, Li-loss control was poor in their firing, which caused a small, and non-uniform particle size distribution. Poor Li-loss controlled firing can cause thin film warping, or even cracking. Cracks are observable in their fired parts having lower Ga doping. W-substituted LLZO has also been investigated at x equal to 0.3 and 0.5 in Li₇₋₂ₓLa₃Zr₂₋ₓWₓO₁₂. The W-substituted material was found to sinter to a high relative density at high temperature, 1100° C., and with large grain size, greater than 5 microns (see L. Dhivya, et al., Li⁺ transport properties of W substituted Li₇La₃Zr₂O₁₂ cubic lithium garnets, AIP Advances, 3 (2013) 082115).

US Patent Publication 20140295287 (WO 2013010692) mentions lithium ion-conducting garnet-like compounds having excess lithium, and method of making a lithium ion-conducting compound, having a garnet-like crystal structure, and having the general formula: Liₙ[A_{(3-a′-a″)}A′_{(a′)}A″_{(a″)}][B_{(2-b′-b″)}B′_{(b′)}B″_{(b″)}][C′_{(c′)}C″_{(c″)}]O₁₂, where A, A′, A″ stand for a dodecahedral position of the crystal structure, where A stands for La, Y, Pr, Nd, Sm, Eu, Gd, Tb, Dy, Ho, Er, Tm and/or Yb, A′ stands for Ca, Sr and/or Ba, A″ stands for Na and/or K, 0<a′<2 and 0<a″<1, where B, B′, B″ stand for an octahedral position of the crystal structure, where B stands for Zr, Hf and/or Sn, B′ stands for Ta, Nb, Sb and/or Bi, B″ stands for at least one element selected from the group including Te, W and Mo, 0<b′<2 and 0<b″<2, where C and C″ stand for a tetrahedral position of the crystal structure, where C stands for Al and Ga, C″ stands for Si and/or Ge, 0<e<0.5 and 0<c″<0.4, and where n=7+a′+2·a″−b′−2·b″−3·c′−4·c″ and 5.5<n<6.875.

In previous work (see the abovementioned copending application U.S. Ser. No. 62/064,605), Ga doping was used to substitute for Li, and sintering temperatures of 950° C. were achieved by doping Ga to 0.5 mol in 1 mol of garnet. In the firing process, the Li-loss was compensated for by using a covering powder and Pt boxes/trays to hold the firing samples. The obtained sintering pellet/film was uniform throughout its thickness. However, the grain size was typically relatively large in the fired pellets. These large size grains are undesirable in a thin tape, which large size grains can cause strength and hermeticity issues.

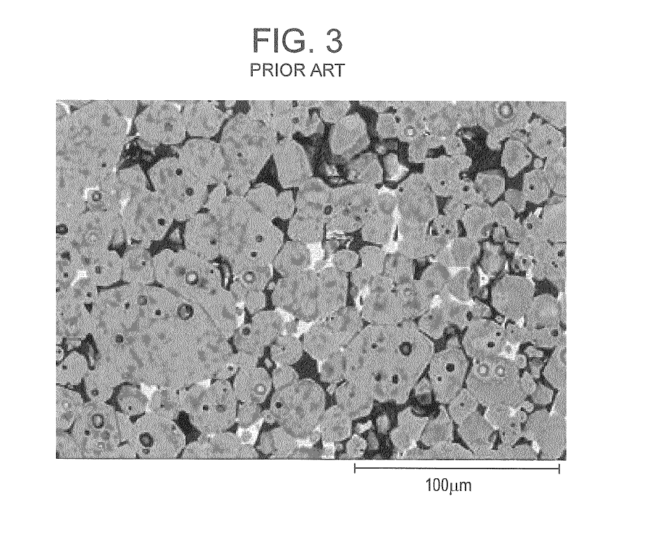

In the same previous work, a method to decrease the grain size by reducing Li and Ga concentration in the raw materials was explored. FIG. 3 of the abovementioned co-pending provisional patent application U.S. Ser. No. 62/064,605, demonstrated the smaller grain structure obtained. However, by reducing both Li and Ga, the sintering temperature was increased.

In embodiments, the present disclosure provides doped garnet compositions having selected dopants that provide a beneficial effect on, for example, garnet sintering temperature, the grain growth, and the phase control. The co-dopants, W—Ga, Nb—Ga, Ta—Ga, and Al—Ga, doped in garnets were prepared. It was discovered that Ga doping reduces the garnet sintering temperature by forming LiGaO₂, which forms a liquid phase at a lower temperature, which lower temperature that enhances the sintering process. When the Ga doping concentration was at 0.5 mol/mol of garnet, all the Ga doped compositions can be sintered at 950° C. The W—Ga doped garnet and Ta—Ga doped garnet each had a stable cubic phase at temperatures from 950° C. to 1150° C., while the other doped garnets developed significant tetragonal phase at 950° C. The W—Ga doped garnet having a low Li concentration, such as from 4.9 to 5.5 mol/mol of garnet, produced fine grains having a diameter of about 1 micron in the membrane when sintered at 950° C.

In embodiments, the present disclosure provides W and Ga (“W—Ga”) co-doped garnet batch compositions and method of making a lithium-oxide garnet composition thereof.

In embodiments, the disclosure also provides a W—Ga co-doped garnet batch composition, comprising or consisting of:
a source of elemental Li in from 41 to 56 mol %;
a source of elemental La in from 25 to 28 mol %;
a source of elemental Zr in from 13 to 17 mol %; and
a source of elemental co-dopant comprising or consisting of a mixture of: a first dopant compound having gallium (Ga) in from 2 to 17 mol %; and a second dopant compound having tungsten (W) in from 0.8 to 5 mol %, based on a batch total of 100 mol %.

In embodiments, in the W—Ga co-doped batch composition,
the source of elemental Li can be, for example, Li₂CO₃ in from about 35 to 48 mol %;
the source of elemental La can be, for example, La₂O₃ in from about 21 to 24 mol %;
the source of elemental Zr can be, for example, ZrO₂ in from about 23 to 28 mol %;
the first dopant compound can be, for example, Ga₂O₃ having Ga in from 2 to 15 mol %; and
the second dopant compound can be, for example, WO₃ having W in from 1 to 8 mol %.

In embodiments, the disclosure also provides a method of making the abovementioned W—Ga lithium-oxide garnet composition, comprising or consisting of:
calcining the W—Ga co-doped garnet batch composition, to form a cubic garnet product;
milling, for example, with jet milling or attrition milling, the cubic garnet product to form a powder product having particles of from 0.2 to 1 microns;
pressing the powder product into a pellet or casting the powder product into a membrane; and
sintering the pressed pellet or casted membrane at from 950 to 1100° C. for from 2 to 30 hrs to form, respectively, a sintered garnet pellet or sintered garnet membrane.

In embodiments, in the first dopant is Ga in from 0.3 to 2.0 mol, and the second dopant is Win from 0.1 to 0.5 mol, for 1 mol of the sintered garnet.

In embodiments, in the W—Ga co-doped garnet batch provides a stable cubic phase garnet at all sintering temperatures from 950 to 1100° C.

In embodiments, the lithium-oxide garnet composition has a small grain size of from 1 to 25 microns, for example, from 1 to 20 microns, from 1 to 10 microns, and from 1 to 2 microns, including intermediate values and ranges, in the sintered garnet. Of the co-doped garnet compositions prepared, only the W and Ga co-doped garnet had this small grain size or fine grains.

In embodiments, the lithium-oxide garnet batch composition has a low sintering temperature of from 950 to 1100° C. in the sintered garnet.

In embodiments, the lithium-oxide garnet composition retains of from 85 to 95 wt % of a cubic garnet phase when the sintering is at 950° C.

In embodiments, the lithium-oxide garnet composition comprises a mixture of a cubic garnet phase and a lithium gallate phase.

In embodiments, the disclosure provides Ta—Ga co-doped garnet batch compositions and method of making Ta—Ga co-doped lithium-oxide garnet composition thereof.

In embodiments, the disclosure provides a Ta—Ga co-doped garnet batch composition, comprising or consisting of:
a source of elemental Li in from 41 to 56 mol %;
a source of elemental La in from 25 to 28 mol %;
a source of elemental Zr in from 13 to 17 mol %; and
a source of elemental co-dopant comprising or consisting of a mixture of: a first dopant compound having gallium in from 2 to 17 mol %; and a second dopant compound having tantalum in from 0.8 to 5 mol %, based on a batch total of 100 mol %.

In embodiments, in the Ta—Ga co-doped batch composition,
the source of elemental Li can be, for example, Li₂CO₃ in from 35 to 48 mol %;
the source of elemental La can be, for example, La₂O₃ in from 21 to 26 mol %;
the source of elemental Zr can be, for example, ZrO₂ 15 to 28 mol %; and
the first dopant compound can be, for example, Ga₂O₃ having Ga in from 2 to 15 mol %; and
the second dopant compound can be, for example, Ta₂O₅ having Ta in from 0.7 to 9 mol %.

In embodiments, the disclosure provides a method of making the abovementioned Ta—Ga lithium-oxide garnet composition, comprising or consisting of:
calcining the Ta—Ga co-doped garnet batch composition, to form a cubic garnet product;
milling, for example, with jet milling or attrition milling, the cubic garnet product to form a powder product having particles of from 0.2 to 1 microns;
pressing the powder product into a pellet or casting the powder product into a membrane; and
sintering the pressed pellet or casted membrane at from 950 to 1100° C. for from 2 to 30 hrs to form, respectively, a sintered garnet pellet or sintered garnet membrane.

In embodiments, the first dopant compound can have, for example, Ga in from 0.3 to 2.0 mol, the second dopant compound can have, for example, Ta in from 0.1 to 1.0 mol, for 1 mol of the sintered garnet.

In embodiments, the Ga and Ta co-doped garnet provides a stable cubic phase garnet at all sintering temperatures of from 950 to 1100° C.

In embodiments, the lithium-oxide garnet composition has a low sintering temperature of from 950 to 1100° C. in the sintered garnet.

In embodiments, the lithium-oxide garnet composition retains of from 85 to 95 wt % of a cubic garnet phase when the sintering is at 950° C.

In embodiments, the lithium-oxide garnet composition comprises a mixture of a cubic garnet phase and a lithium gallate phase.

In embodiments, the disclosure provides a Li-metal containing energy storage device comprising or consisting of:
a solid electrolyte membrane comprising or consisting of the co-doped Ta—Ga garnet made by the above method.

In embodiments, the disclosure provides a Li-metal containing energy storage device comprising or consisting of:
a solid electrolyte membrane comprising or consisting of the co-doped W—Ga garnet made by the above method.

In embodiments, the Li₂CO₃ can be present in an amount of, for example, 19.64 wt %, the La₂O₃ can be present, for example, in an amount of 48.21 wt %, the ZrO₂ can be present, for example, in an amount of 20.66 wt %, the WO₃ can be present, for example, in an amount of 6.86 wt %, and the Ga₂O₃ can be present, for example, in an amount of 4.62 wt %.

The present disclosure is advantaged is several aspects, including for example:
A high Ga dopant concentration, for example, of from 0.4 to 2 mol Ga per 1 mol of garnet, in the batch starting material can greatly reduce the sintering temperature by in situ formation of LiGaO₂ in a Li rich environment. LiGaO₂ can act as a sintering aid.

W doping substitutes for both Li and Zr atoms in the garnet, which W substitution reduces the Li concentration in the garnet and helps to form small grains in the sintered parts, which parts have higher strength and hemeticity compared to the garnet made without the W doping.

W and Ga co-doping permits the garnet to be sintered at lower temperatures and the resulting garnet has smaller grains in the sintered part compared to a singly doped, and some other co-doped garnet systems.

The cubic phase is stable at all sintering temperatures, especially at low sintering temperatures, for example, from 800 to 1000° C., where the cubic phase stability is low in many other system.

In embodiments, the present disclosure provides a method of making a lithium-oxide garnet composition having a low sintering temperature and having a small grain size in a sintered garnet part.

In embodiments, the present disclosure provides a method of making a sintered garnet part by co-doping with W and Ga to substitute for Li and Zr atoms.

In embodiments, the disclosed method of making the lithium-oxide garnet composition, that includes co-doping with W and Ga, can provide a garnet that can be sintered to near full density at temperatures as low as, for example, 950° C. Grain sizes of, for example, from 1 to 5 microns can be achieved. The W doping can be, for example, from 0.1 to 0.5 mol, and the Ga doping can be, for example, from 0.3 to 2.0 mol in 1 mol of garnet, including intermediate values and ranges.

In embodiments, the disclosed method of making the garnet includes W doping, which substitutes both Li and Zr atoms in the garnet. This doping substitution reduces the stoichiometric Li composition, which helps to form small grains in the sintered parts. Small grain sintered parts have higher strength and hemeticity.

In embodiments, co-doping with W and Ga permits the garnet to be sintered at lower temperatures and the garnet product has smaller grains in the sintered part compared to a single or individually doped garnet.

Co-doping with W and Ga, or with Ta and Ga, permits the garnet product to be sintered at lower temperatures in a Li rich environment, and the cubic phase is also stable at lower temperatures.

In embodiments, the disclosure provides a method for making a garnet membrane that contains small grains, for example, of from about 1 to 5 microns, such as 1 micron, 2 microns, 3 micron, 4 microns, or 5 microns, including intermediate values and ranges. The small grain size membranes can provide higher strength compared to membranes that contain larger grains, such that the grain size is much smaller compared to the membrane thickness of from about 20 to 200 microns. The membrane firing temperature can be below, for example, 1050° C., 1000° C., or 950° C., including intermediate values and ranges.

In embodiments, the disclosure provides a method for making the disclosed garnet comprising doping the garnet with W and Ga. The W substitutes for part of the Li and the Zr in the garnet, and the Ga substitutes for the Li in the garnet. The W doping range can be, for example, from 0.1 to 0.5 mol, and Ga doping range can be, for example, from 0.3 to 2.0 mol in 1 mol of the garnet, including intermediate values and ranges.

In embodiments, the garnet can be made directly by a solid state reaction using, for example, oxides, carbonates, or any other suitable type of solid precursor compounds. The garnet can also be made through a nano-material route by first preparing nano-sized precursors by, for example, sol-gel, non-flame combustion, or other nano material preparative methods. The precursors are then fired to form a cubic garnet.

The cubic garnet powder can be ground to a particle size (D50) of, for example, 0.1 to 10 microns, 0.2 to 5 micron, or like sized particles, including intermediate values and ranges. Jet mill or attrition mill methods can be used for particle sizing.

In embodiments, the W and the Ga co-doped garnet membranes can be made by, for example, tape casting or pellet pressing.

In embodiments, sintering of the garnet tapes or pellets can be accomplished by holding in a Pt tray having a tight cover. A high sintering temperature garnet powder, such as an aluminum-doped garnet powder can be used to line the bottom of the tray. For pellets, the high sintering temperature garnet can also be used to cover the top of the pellets. This garnet powder should contain 10 to 25 mol % more Li than the stoichiometric garnet. During sintering, for tapes or pellets that contain organic binder, a debinding hold temperature at of from 400° C. to 700° C. can be used to remove organic binder materials first. The top firing temperature can be at or below, for example, 1050° C., 1000° C., or below 950° C., including intermediate values and ranges.

In embodiments, the disclosure provides a solid electrolyte membrane having at least one of the nominal formulas: Li_{5.7}La₃Zr_{1.7}Ga_{0.5}Ta_{0.3}O_{12.25}; Li_{5.4}La₃Zr_{1.7}W_{0.3}Ga_{0.5}O_{12.25}; or a combination thereof.

### EXAMPLES

The following Examples demonstrate making, use, and analysis of the disclosed lithium-oxide garnet composition, solid electrolyte membranes, and energy storage articles.

### Example 1

### W—Ga—Co-Doped Garnet Batch Starting Material

Li₂CO₃, La₂O₃, ZrO₂, Ga₂O₃, and WO₃ were used as the starting materials (i.e., reactants) or as the garnet precursors. The precursors were mixed together in the weight % listed in the Table 1, to target a garnet composition of the formula Li_{5.4}La₃Zr_{1.7}W_{0.3}Ga_{0.5}Oₓ. In this batch composition Li₂CO₃ was over-batched by a 10 weight % excess over a stoichiometric garnet. The above formula is not stoichiometric, and includes a 10 wt % excess of Li.

TABLE 1
W—Ga co-doped garnet batch composition ingredients.

| Reactants | Li₂CO₃ | La₂O₃ | ZrO₂ | WO₃ | Ga₂O₃ |
|---|---|---|---|---|---|
| weight % | 19.65% | 48.21% | 20.66% | 6.86% | 4.62% |

Table 2 below lists other co-doped garnet compositions that were prepared by the disclosed method.

TABLE 2
Other co-doped garnet compositions.

| | Composition (nominal | Material |
|---|---|---|
| General Formula¹ | formula) | Code |
| Li_{7-3x-y}La₃Zr_{2-y}GaₓNb_{y}O₁₂ | Li_{5.7}La₃Zr_{1.7}Ga_{0.5}Nb_{0.3}O_{12.25} | MWC |
| Li_{7-3x-y}La₃Zr_{2-y}GaₓTa_{y}O₁₂ | Li_{5.7}La₃Zr_{1.7}Ga_{0.5}Ta_{0.3}O_{12.25} | MWD |
| Li_{7-3x-3y}La₃Zr₂GaₓAl_{y}O₁₂ | Li_{5.4}La₃Zr₂Ga_{0.5}Al_{0.2}O_{12.25} | MWE |
| Li_{7-3x-2y}La₃Zr_{2-y}GaₓW_{y}O₁₂ | Li_{5.4}La₃Zr_{1.7}W_{0.3}Ga_{0.5}O_{12.25} | MAA |
| Li₇₋₃ₓLa₃Zr₂GaₓO₁₂ | Li_{6.5}La₃Zr₂Ga_{0.58}O_{12.62} | LPG |
| Li_{7-2y}La₃Zr_{2-y}W_{y}O₁₂ | Li_{7.04}La₃Zr_{1.7}W_{0.3}O_{12.32} | LZZ |

¹where x is from 0.2 to 2.0, and y is from 0.1 to 1.0.

### Example 2

### Cubic Garnet Formation

The well mixed powder mixture of Example 1 was calcined using the following schedule:
ambient or room temperature (RT) to 900° C., 100° C./min
   900° C. hold for 2 hrs
   900° C. to 1100° C., 100° C./min
   1100° C. hold for 6 hrs
   1100° C. to RT, 200° C./min

After the calcination, the powder was measured by XRD. The XRD results are presented in Table 3. All of the Table 3 compositions formed greater than 90 wt % of cubic garnet and a minor amount of LiGaO₂, except for an LZZ composition (Material Code: LZZ) that does not contain Ga.

TABLE 3
XRD analyzed phase compositions in the garnet
compositions having different dopants.

| | reactant weight ratios | |
|---|---|---|
| | wt % cubic phase to wt % | Material |
| Composition | (others) | Code |
| Li_{5.7}La₃Zr_{1.7}Ga_{0.5}Nb_{0.3}O_{12.25} | 92:8 (LiGaO₂) | MWC |
| Li_{5.7}La₃Zr_{1.7}Ga_{0.5}Ta_{0.3}O_{12.25} | 94:3 (LiGaO₂):1 (La₂Zr₂O₇):2 | MWD |
| | (Li₃TaO₄) | |
| Li_{5.4}La₃Zr₂Ga_{0.5}Al_{0.2}O_{12.25} | 96:2 (LiGaO₂):2 (La₂Zr₂O₇) | MWE |
| Li_{5.4}La₃Zr_{1.7}W_{0.3}Ga_{0.5}O_{12.25} | 93:1 (La₂Zr₂O₇):2 (LiGaO₂):2 | MAA |
| | (Li₂ZrO₃):2 (Li₄WO₅) | |
| Li_{6.5}La₃Zr₂Ga_{0.58}O_{12.62} | 95:3 (LiGaO₂):2 (Li2₂ZrO₃) | LPG |
| Li_{7.04}La₃Zr_{1.7}W_{0.3}O_{12.32} | 97:1 (Li₂ZrO₃):2 (La₂O₃) | LZZ |

### Example 3

### Powder Milling to Submicron Particle Size

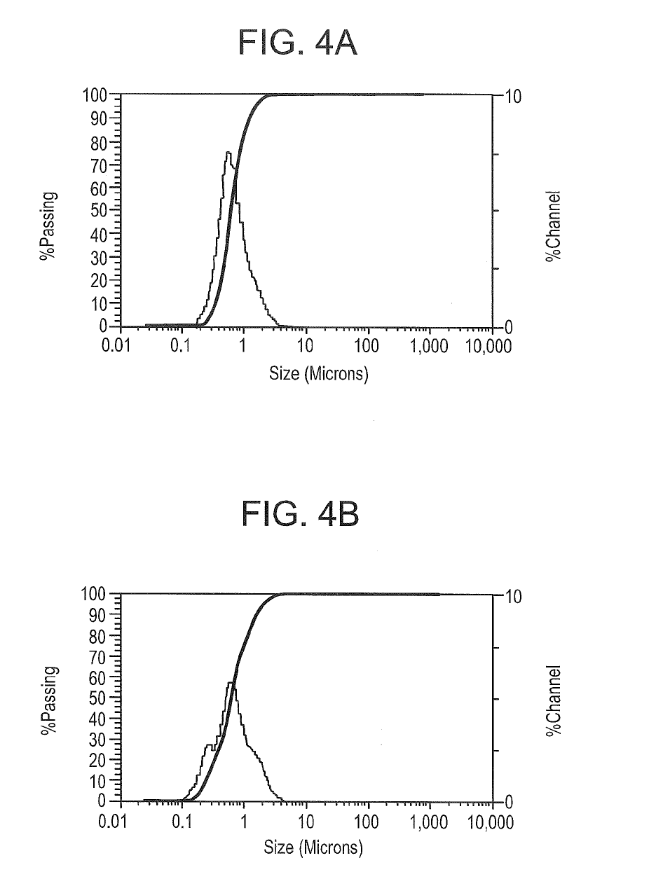

The powder of Example 2 was jet milled. Referring to the Figures, FIGS. 4A and 4B show, respectively, the particle size distribution of a jet milled cubic garnet powder (FIG. 4A), and the attrition milled garnet powder (FIG. 4B), respectively. FIG. 4A shows the particle size distribution of the jet milled powder. The distribution has a maximum at 0.688 microns.

Attrition milling was also used for breaking down agglomerates and larger particle size materials. In the disclosed process an Eiger attrition (M50) mill was used with 1 mm zirconia media in, for example, a mixture of ethanol, 1-butanol, propylene glycol, and Anti-terra 202 deforming agent.

All components were mixed together in a container and then transferred to the funnel of the Eiger mill while the mill was operating. Once loaded with the complete mill batch the mill speed was set to 4,000 rpm. Milling time for this mill batch was 5 hrs. The obtained powder particle size D50 was 0.621 micron (see FIG. 4B). The milled slurry can be used for tape casting. To make garnet powder, only ethanol was used in the mill batch, and the milled slurry was dried to obtain the garnet powder.

### Example 4

### Garnet Pellets

The submicron powder of Example 3 was pressed into pellets using 66,750 N (15,000 pounds) force. The green pellet diameter was 28.5 mm.

### Example 5

### Garnet Tapes

Garnet tapes were made by casting thin, uniform sheets of slip and allowing them to dry in a controlled process. The process for making this tape began with making a garnet slip consisting of the garnet mill batch (or powders in some instances) and an organic vehicle including, for example, a solvent, a binder, and a plasticizer. It is significant to ensure that the starting particle size of the garnet material is at the desired particle size to achieve a final sintered garnet membrane having an ideal grain size. Table 4 lists the slip composition. The dibutyl phthalate is a plasticizer, which additive gives the green tape improved flexibility and durability for handling prior to sintering.

TABLE 4
Example slip batch ready for casting.

| Ingredient | Wt (gm) |
|---|---|
| MAA¹ garnet powder | 17 |
| (0.6 microns) | |
| solvent mixture² | 3.3 |
| Dibutyl phthalate | 1.88 |
| PVB-B79³ | 0.63 |
| PVB-B98³ | 1.26 |
| Anti-terra 202 (dispersant)⁴ | 0.34 |

¹Material code, see Tables 2 and 3.
²Solvent mixture: ethanol (77.11 wt %), butanol (18.65 wt %), and propylene glycol (4.24 wt %).
³Organic binders include polyvinyl butyrals (PVB-B79 and PVB-B98) available from Butvar.
⁴Available in North America from Altana/Byk Additives.

Once the ingredients were combined they were mixed in a Mazerustar mixer for 30 min. Once the slip was made it was ready for casting. The casting process consists of a carrier film placed onto a smooth surface (in this instance it was a sheet of glass). The slip is then poured in front of doctor blade that has a machined gap for the desired thickness. As the blade moves down the caster bed it leaves a uniform layer of slip. This was dried in an environment having a relative humidity of about 25% to 45%, low air flow, and temperature set at 70° F. It is significant that the green tape is removed once able as determined by inspection and not left on the carrier film since it will crack due to shrinkage if the tape is allowed to dry too much. The casting thickness in this example was 30 microns but other thicknesses of the green tape can be readily prepared.

### Example 6

### Garnet Pellets Sintering

For pellets that were to be fired, they were imbedded in an aluminum-doped cubic garnet powder having a composition of the formula Li_{6.9}La₃Zr₂Al_{0.25}O_{12.325}. The following schedule was used for pellet sintering:
RT to top temperature, 100° C./hr,
Top temperature hold for 7 to 30 hrs, and
Top temperature to RT, 200° C./hr.

The top temperature holding time was: 1050° C. for 7 hrs, 1000° C. for 15 hrs, 975° C. for 30 hrs, and 950° C. for 30 hrs.

Table 5 lists the Li-ion conductivity (measured by AC impedance) of the sintered pellet. Table 5 also indicates by the “dense (YES/NO)” designation if the pellets are fully sintered (i.e., “Yes”) after firing to different temperatures.

With only (i.e., exclusively) W-doping (e.g., the LZZ sample), the garnet did not sinter at a temperature lower than 1050° C. For samples having Ga-doping (i.e., solely or co-doped)(e.g., the MAA and LPG samples), all such samples can be sintered at a temperature as low as 950° C. A sintered pellet has bulk density of greater than 95% of the density measured by a He pycnometer. The Li-ion conductivities of the sintered pellets prepared in this Example were on the order of 10⁻⁴ S/cm.

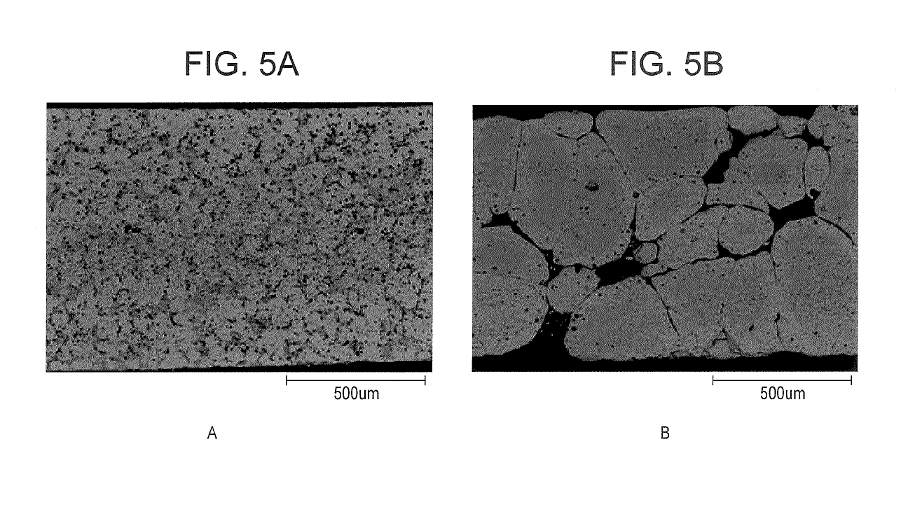

FIGS. 5A and 5B show SEM images of the polished cross-section of the pellet made from a W and Ga co-doped garnet (FIG. 5A); and a Ga only doped garnet (FIG. 5B). EDS and XRD shows that the black features inside the pellets at the grain boundaries are predominantly LiGaO₂. With doping only of Ga, the sintered garnet forms large grains, for example, from 100 to 500 microns. With co-doping with W and Ga, the sintered garnet pellets contain much smaller grains, for example, of from 0.5 to 1.5 microns.

TABLE 5
Comparison of differently doped garnet pellets in
sintering,¹ and their Li-ion conductivities after
being fired at different temperatures and times.

| | | 1050° C., | | | |
|---|---|---|---|---|---|
| | Powder cubic | 7 hr, dense | | | |
| | phase | (Yes/No) ionic | | | |
| | concentration | conductivity | 1000° C. | 975° C. | 950° C. |
| Samples | (wt %) | (10⁻⁴ S/cm) | 15 hr | 30 hr | 30 hr |
| LZZ | 97 | No | No | na² | na² |
| (W- | | | | | |
| doped | | | | | |
| garnet) | | | | | |
| MAA | 93 | Yes | Yes | Yes | Yes |
| (W, | | 2.38 | 2.83 | 1.64 | 2.93 |
| Ga co- | | | | | |
| doped | | | | | |
| garnet) | | | | | |
| LPG | 95 | Yes | Yes | Yes | Yes |
| (Ga- | | 7.7 | 6.02 | 4.94 | 4.30 |
| doped | | | | | |
| garnet) | | | | | |

¹Using a “marker test”, if the marker ink spreads, then the pellet is not sintered, i.e., “No”.
²“na” indicates not accomplished.

### Example 7

### Garnet Tape Sintering

For casted tapes that were to be fired, they were laid in an aluminum-doped cubic garnet powder lined Pt tray. The aluminum-doped garnet composition is Li_{6.9}La₃Zr₂Al_{0.25}O_{12.325}. The following schedule was used for garnet tape sintering:
RT to 600° C., 100° C./hr;
   600° C. hold for 2 hr;
600° C. to top temperature, 100° C./hr;
Top temperature hold for 5 hr; and
Top temperature to RT, 200° C./hr.

Two top temperatures were used in the tape sintering: 1000° C. and 950° C. The 1000° C. fired tapes were dark brown. The 950° C. fired tape was translucent. An AC impedance method was used for Li-ion conductivity measurement. The Li-ion conductivities were 1.5×10⁻⁴ S/cm and 3.0×10⁻⁴ S/cm for 1000° C. and 950° C. firing, respectively.

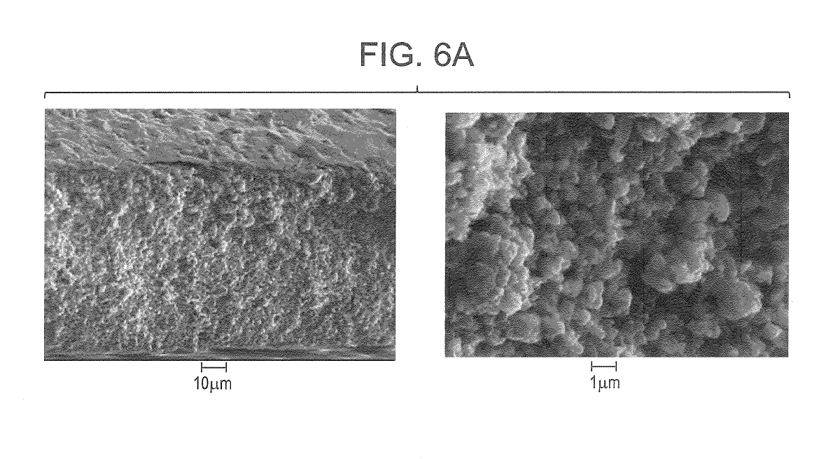

FIGS. 6A and 6B, respectively, show SEM images of the W and Ga co-doped garnet tapes fired at 950° C. and 1000° C. for 5 hrs. The 950° C. fired tape microstructure was uniform. The grain size was about 1 micron. This uniform and small grain film structure makes the tape translucent. In the 1000° C. fired tape, some larger grains of about 10 microns formed, although the majority of the grains were still about 1 micron. The tape had a thickness of 75 microns. FIG. 6B shows SEM images of the cross-section of a W and Ga co-doped garnet tape fired to 1000° C. for 5 hrs. The scale bars represent 10 microns (left) and 1 micron (right), respectively.

### Example 8

### XRD Characterizations

Table 6 lists the XRD measured cubic/tetragonal phase composition for powder made at 1100° C. and pellets sintered at 950° C. After the solid state reaction at 1100° C. for 6 hrs, all the powder forms a greater than 90 wt % cubic phase. However, after pellet sintering at 950° C. for 30 hrs, some compositions developed a large amount of tetragonal phase, such as compositions MWC and MWE, while the other compositions retained high cubic phase concentrations. Those compositions having a large developed tetragonal phase have significantly lower Li-ion conductivities (measured by AC impedance method). These results suggest that Ta and W secondary co-dopants help to stabilize the cubic phase at lower firing temperatures.

TABLE 6
XRD measured concentrations of cubic phase and tetragonal phase,
and the corresponding membrane Li-ion conductivities.

| | wt % cubic phase | pellet phase | |
|---|---|---|---|
| | quantification | quantification sintered | |
| Material | (1100° C./6 hr | at 950° C./30 hrs | Li-ion |
| Code, | formed garnet | wt % ratio of | conductivity |
| co-dopants | powder) | (cubic:tetragonal:other(s)) | (S/cm) |
| MWC, | 92 | 30:61:5 (LiGaO₂):4 | 1.3 × 10⁻⁵ |
| Nb—Ga | | (LiNbO₃) | |
| MWD, | 94 | 89:0:11 (LiGaO₂) | 1.8 × 10⁻⁴ |
| Ta—Ga | | | |
| MWE, | 96 | 51:42:7 (LiGaO₂) | 6.8 × 10⁻⁶ |
| Al—Ga | | | |
| MAA, | 93 | 92:0:5 (LiGaO₂):3 | 4.2 × 10⁻⁴ |
| W—Ga | | (Li₄WO₅) | |
| (0.3 W) | | | |

Garnet Membrane Characterizations—Microstructure and Grain Size

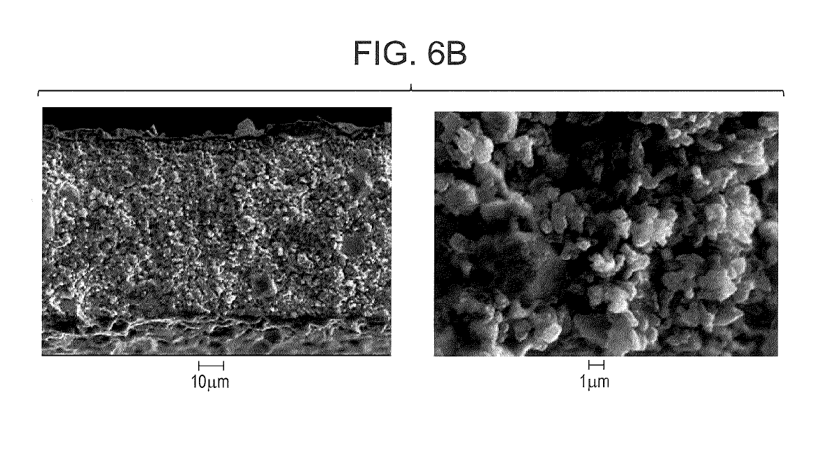

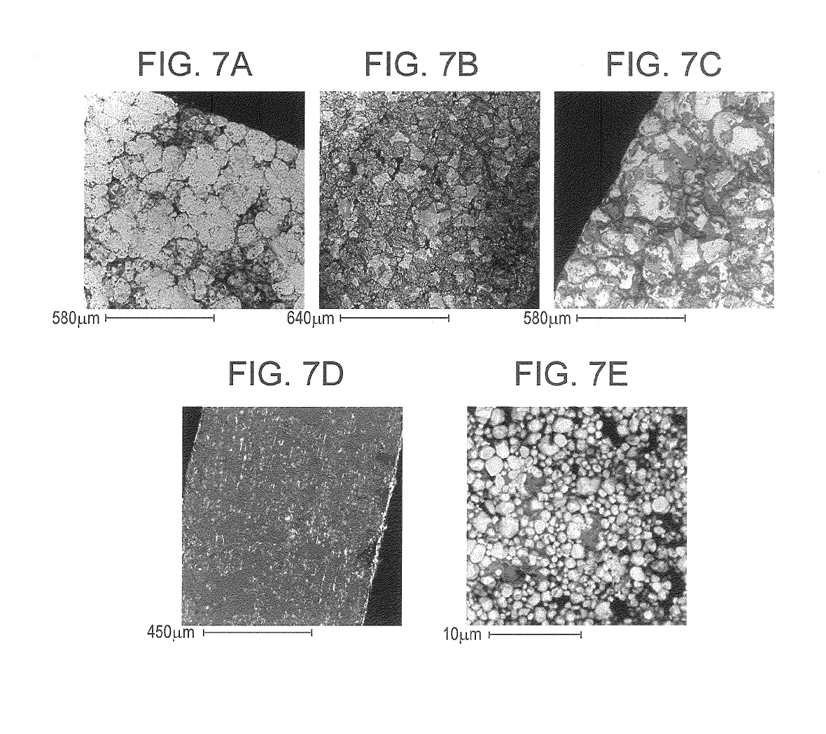

FIGS. 7A to 7E show cross-section SEM images of some of the disclosed pellets made by the pellet pressing method and sintered at 950° C. All of the sample sintered well and passed the marker test (i.e., no spreading of the marker ink when painted on the sample surfaces). SEM shows dense structure of each of the samples, with different microstructures. The MWC (Nb—Ga co-doped), and MWE (Al—Ga co-doped) garnets have round shape sintered grains. The MWD (Ta—Ga co-doped) garnet has a more random shape and crystalline facet grains, which indicates that this garnet composition may have smaller surface energy in the molten phase. The MAA (W—Ga co-doped and with 0.3 W) garnet has a fine grain size of about 1 micrometer. Within the larger grain SEM images, the MWC and MWD samples showed more 2D images, which indicates that a fracture went through the garnet grains. The MWE show more 3D images, which indicates that the fracture went through the grain boundaries, and the SEM images showed some curved grain surfaces and some fractured grain surfaces. The darker features are from the LiGaO₂ located at grain boundaries, showing larger areas in the images than those in the images of MWC and MWD, in which the grain boundaries are imaged as lines between fractured grains. This observation suggests that the MWC and MWD garnet may be weaker than the bonding materials (LiGaO₂) in the sintered pellet membranes. The MWE and NJV garnet grains may be stronger than the bonding materials. Understanding the relative strengths of the grain and bonding materials is significant in designing strong thin membranes where only one or two grains may cross the membranes. A stronger bonding material is desired for such large grain membranes. A fine grain membrane structure, as shown by the MAA structure, is a desired structure for high strength and high hermeticity thin membranes.

FIGS. 7A to 7E shows fractured cross-section SEM images of selected garnet composition membranes made by pellet pressing after sintering at 950° C. for 30 hrs. FIG. 7A is a MWC (Nb—Ga) garnet composition having a grain size of about 100 microns. FIG. 7B is a MWD (Ta—Ga) garnet composition having a grain size of about 60 microns. FIG. 7C is a MWE (Al—Ga) garnet composition having a grain size of about 200 microns. FIGS. 7D (low magnification) and 7E (high magnification) are for a MAA (W—Ga, 0.3 W) garnet composition having a grain size of about 1 micron.

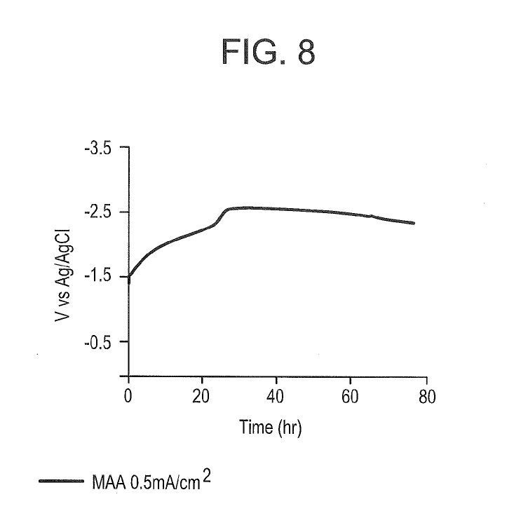

FIG. 8 shows cell test measurement results for an exemplary 0.5 mm thick doped garnet (MAA; a W, Ga co-doped garnet of the formula Li_{5.4}La₃Zr_{1.7}W_{0.3}Ga_{0.5}O_{12.25}) pellet at a current density of 0.5 mA/cm². The cell test measurements were made using standard methods.

### Example 9

### Energy Storage Article

US Patent Publication US 20140227614, mentions a solid ion conductor including a garnet oxide, a solid electrolyte including the conductor, a lithium battery including the solid electrolyte, and method of manufacturing the solid ion conductor, the entire disclosure of which is incorporated herein by reference. The general teachings of making an energy storage article disclosed in US 20140227614 and elsewhere, can be used to make an energy storage article from at least one of the presently disclosed co-doped garnet batch compositions, such as a Li-metal containing energy storage device.

The disclosure has been described with reference to various specific embodiments and techniques. However, it should be understood that many variations and modifications are possible while remaining within the scope of the disclosure.

What is claimed is:

1. A co-doped garnet batch composition, comprising:
a source of elemental Li in from 41 to 56 mol %;
a source of elemental La in from 25 to 28 mol %;
a source of elemental Zr in from 13 to 17 mol %; and
a source of elemental co-dopant comprising a mixture of: a first dopant compound having gallium in from 2 to 17 mol %, and a second dopant compound having tungsten in from 0.8 to 5 mol %, based on a batch total of 100 mol %.

2. The co-doped batch composition of claim 1 wherein
the source of elemental Li is Li₂CO₃ in from about 35 to 48 mol %;
the source of elemental La is La₂O₃ in from about 21 to 24 mol %;
the source of elemental Zr is ZrO₂ in from about 23 to 28 mol %;
the first dopant compound is Ga₂O₃ having Ga in from 2 to 15 mol %; and
the second dopant compound is WO₃ having W in from 1 to 8 mol %.

3. A method of making the lithium-oxide garnet composition, comprising:
calcining the co-doped garnet batch composition of claim 1, to form a cubic garnet product;
milling the cubic garnet product to form a powder product having particles of from 0.2 to 1 microns;
pressing the powder product into a pellet or casting the powder product into a membrane; and
sintering the pressed pellet or casted membrane at from 950 to 1100° C. for from 2 to 30 hrs to form a sintered garnet pellet or sintered garnet membrane.

4. The method of claim 3 wherein the first dopant is Ga in from 0.3 to 2.0 mol, and the second dopant is W in from 0.1 to 0.5 mol, for 1 mol of the sintered garnet.

5. The method of claim 3 wherein the W and Ga co-doped garnet batch provides a stable cubic phase garnet at all sintering temperatures.

6. The method of claim 3 wherein lithium-oxide garnet composition has a small grain size of from 1 to 5 microns in the sintered garnet.

7. The method of claim 3 wherein lithium-oxide garnet composition has a low sintering temperature of from 950 to 1100° C. in the sintered garnet.

8. The method of claim 3 wherein the lithium-oxide garnet composition retains of from 85 to 95 wt % of a cubic garnet phase when the sintering is at 950° C.

9. The method of claim 3 wherein the lithium-oxide garnet composition comprises a mixture of a cubic garnet phase and a lithium gallate phase.

10. A Ta and Ga co-doped garnet batch composition, comprising:
a source of elemental Li in from 41 to 56 mol %;
a source of elemental La in from 25 to 28 mol %;
a source of elemental Zr in from 13 to 17 mol %; and
a source of elemental co-dopant comprising a mixture of: a first dopant compound having gallium in from 2 to 17 mol %, and a second dopant compound having tantalum in from 0.8 to 5 mol %, based on a batch total of 100 mol %.

11. The co-doped batch composition of claim 10 wherein:
the source of elemental Li is Li₂CO₃ in from 35 to 48 mol %;
the source of elemental La is La₂O₃ in from 21 to 26 mol %;
the source of elemental Zr is ZrO₂ 15 to 28 mol %; and
the first dopant compound is Ga₂O₃ having Ga in from 2 to 15 mol %; and
the second dopant compound is Ta₂O₅ having Ta in from 0.7 to 9 mol %.

12. A method of making the lithium-oxide garnet composition, comprising:
calcining the co-doped garnet batch composition of claim 10, to form a cubic garnet product;
milling the cubic garnet product to form a powder product having particles of from 0.2 to 1 microns;
pressing the powder product into a pellet or casting the powder product into a membrane; and
sintering the pressed pellet or casted membrane at from 950 to 1100° C. for from 2 to 30 hrs to form a co-doped and sintered garnet pellet or a co-doped and sintered garnet membrane.

13. The method of claim 12 wherein the first dopant compound has Ga in from 0.3 to 2.0 mol, the second dopant compound has Ta compound in from 0.1 to 1.0 mol, and, for 1 mol of the sintered garnet.

14. The method of claim 12 wherein the Ga and Ta co-doped garnet provides a stable cubic phase garnet at all sintering temperatures.

15. The method of claim 12 wherein the lithium-oxide garnet composition has a low sintering temperature of from 950 to 1100° C. in the sintered garnet.

16. The method of claim 12 wherein the lithium-oxide garnet composition retains of from 85 to 95 wt % of a cubic garnet phase when the sintering is at 950° C.

17. The method of claim 12 wherein the lithium-oxide garnet composition comprises a mixture of a cubic garnet phase and a lithium gallate phase.

18. A Li-metal containing energy storage device comprising:
a solid electrolyte membrane comprising the garnet made by the method of claim 12.

19. A Li-metal containing energy storage device comprising:
a solid electrolyte membrane comprising the garnet made by the method of claim 3.
